(19) United States
(12) Patent Application Publication
(10) Pub. No.: US 2010/0243836 A1
(43) Pub. Date: Sep. 30, 2010

(54) VIAL HOLDER WITH SIDE GRIPPING AND CLAMPING HOLDING

(76) Inventor: Olivier Gluck, Mittelbronn (FR)

Correspondence Address: Steven W Weinrieb;Law Ofrfice Of, Steven W Weinrieb, 8717 Cold Spring Road, Potomac, MD, 20854, US

(21) Appl. No.: 12/734,333

(22) PCT Filed: Oct. 14, 2008
(86) PCT No.: PCT/FR2008/001445

§ 371 Date: Apr. 26, 2010

(30) Foreign Application Priority Data
Oct. 24, 2007 (FR) 0707453

(51) Int. Cl. F16M 13/02

(52) U.S. Cl. 248/231.81

(57) ABSTRACT

The invention relates to a holder for one or more vials that comprises a rear attachment platen (2) including one or more side clamping means in the form of clamps (4), each clamp being connected to or removably mounted on the platen. Each clamp includes two opposite curved blades (5), the main portion of each blade being convex and the free end oriented towards the outside in order to define an inlet gap opened towards the outside and an inner holding volume having a generally elongated shape, e.g. oval, between each blade of each clamp for receiving therein a vial (7) with clamping side holding. The vial holder may include a bearing means (10) at each pair of clamps in the form of an L-shaped strip (11) having its upper vertical portion connected to or removably mounted on the rear attachment platen, while its lower horizontal portion (13) has a free end (14).

The present invention concerns a holder for at least one vial with lateral clamping holding. More particularly, the invention relates to an individual holder for a vial of liquid soap, shampoo, or the like, with cross section of elongated shape.

At present, holders for vials are particularly practical, for they make it possible, at the same time, to arrange the vials in a row, maintain them in position, and keep them within easy reach.

The purpose of the invention is to provide a holder for one or more vials, preferably for at least one vial of toiletry products, such as liquid soap, shower gel, shampoo, body care or the like, which can be adapted to vials of different shape, even in the form of tubes, and keep them in a straight position.

More particularly, the purpose of the invention is to enable the lateral holding in upright position of cylindrically shaped vials with round or oblong cross section.

To solve this technical problem, the invention comprises a rear attachment platen intended to be attached or connected to a wall, which rear attachment platen has one or more vial clamping means. Each vial clamping means is in the form of a clamp with two essentially flat, flexible branches, curved and convex toward the outside, facing each other, joined together at a first end of the clamp on the side with the rear attachment platen and free at a second end, forming between them an entry space for the vial and bounding between them a volume of oblong cross section, open toward the outside. The entry space is formed by the outer extremity of each free end of each branch forming the clamp.

The oblong shape of the receiving volume bounded by each pair of clamps can be advantageously adapted to vials having a great variety of cross sections of oblong shape, whether solid or not, and it is particularly adapted to the holding of vials of cylindrical shape with oval cross section by exerting an essentially uniform pressure on the entire body.

Indeed, at present there are many shampoo or soap vials having a general oval-shaped cross section, but no vial holder is particularly adapted to this kind of shape.

Moreover, the clamp or clamps of the vial holder of the invention ensure not only a holding of the vials, but constitute a particularly simple means of holding and immobilization, making it possible to easily introduce a vial and to remove it just as easily and quickly with a single hand and no particular effort.

When holding one or more vials of shower gel, shampoo, or other body care type products, the vial holder of the invention makes it possible to use a vial or vials in a position such that its or their contents can flow at once until emptied.

The holder according to the invention makes it possible to place and hold the vials in a position of use.

The vial holder of the invention also makes it possible to neatly arrange the various vials in the course of use.

However, if a vial is too heavy, it may happen that the clamping force is not enough to hold it and the vial will slide out from the clamp and fall. In the case of vials of toiletry products and particularly shower products: liquid soap, shampoo, conditioner, bubble bath, and others, this phenomenon of slipping may be amplified by a lubrication effect due to the presence of water and/or soap, shampoo, or the like on the outer surface of the vial or on the clamping surfaces of the blades of the clamps. Thus, in one preferred embodiment of the invention, the vial holder also comprises a support means at each clamp, each support means being in the form of a downward extension with an angle on which one end of the vial can rest.

In another variant of the invention, each lateral clamping means in the form of a clamp is moreover removable from the rear attachment platen. Besides manufacturing and packaging ease and simplicity, this removable and separable feature allows in particular a changing of clamp, for example, when it is broken, or when one wishes to replace it with a clamp of different size or shape. Advantageously, the support means can also be removed from the vial holder.

Other characteristics and advantages of the invention will appear from reading the following detailed description, making reference to the attached drawings, in which:

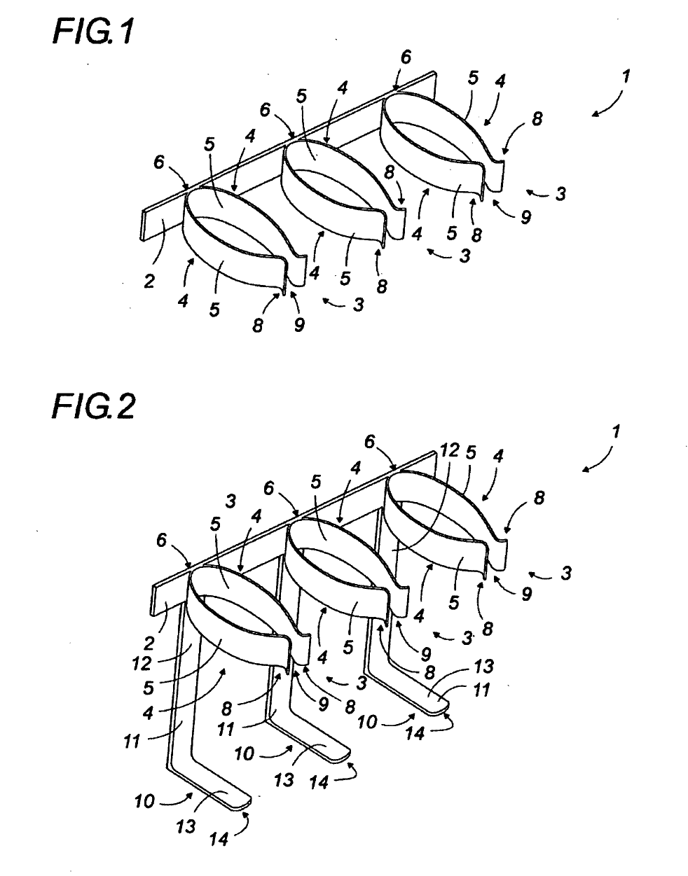

FIG. 1 is a perspective view of a vial holder according to a first embodiment of the invention;

FIG. 2 is a perspective view of a vial holder according to a second embodiment of the invention;

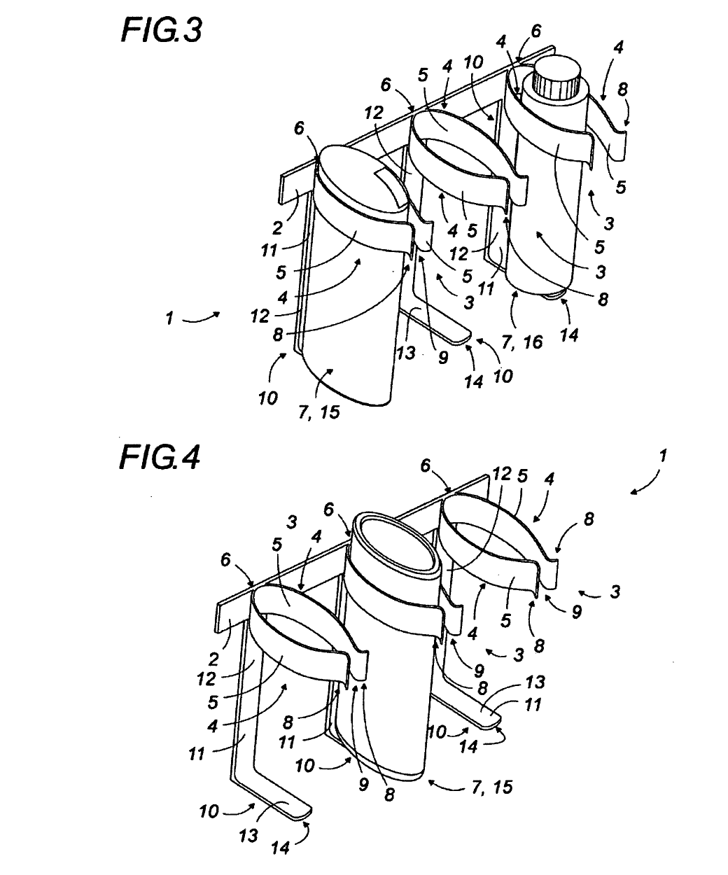

FIG. 3 is a perspective view of the vial holder of FIG. 2 in which two vials of different shape are immobilized;

FIG. 4 is a perspective view of the vial holder of FIG. 2 in which a vial of cylindrical shape and oval cross section is immobilized upside down;

FIG. 5 is a perspective view of a vial holder according to a first variant of the invention;

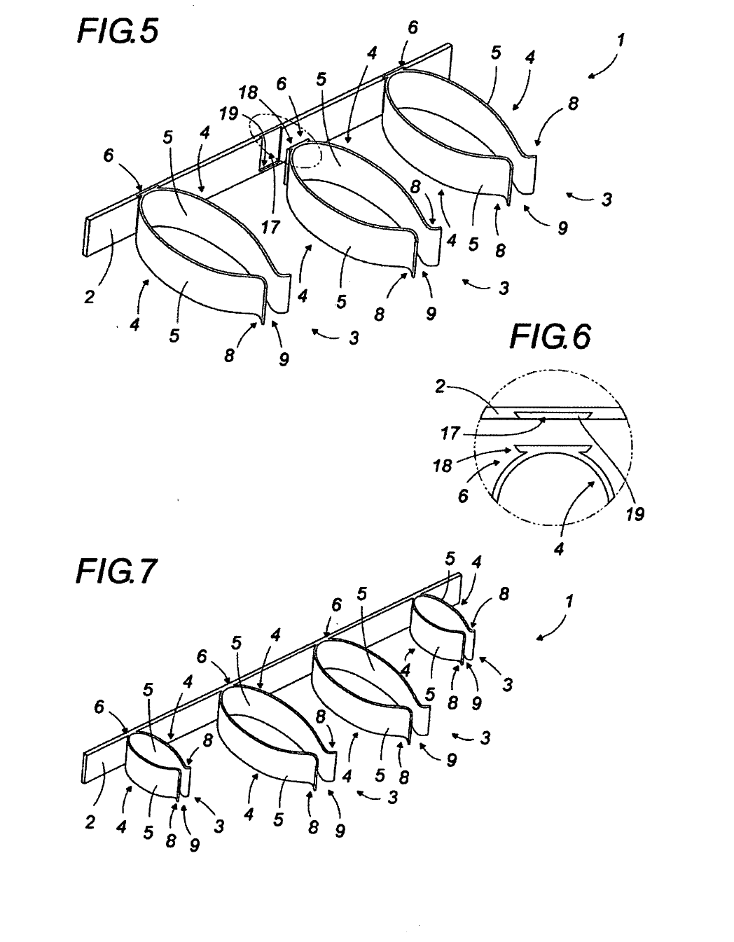

FIG. 6 is a detail top view corresponding to the encircled zone in FIG. 5;

FIG. 7 is a perspective view of a vial holder according to a second variant of the invention;

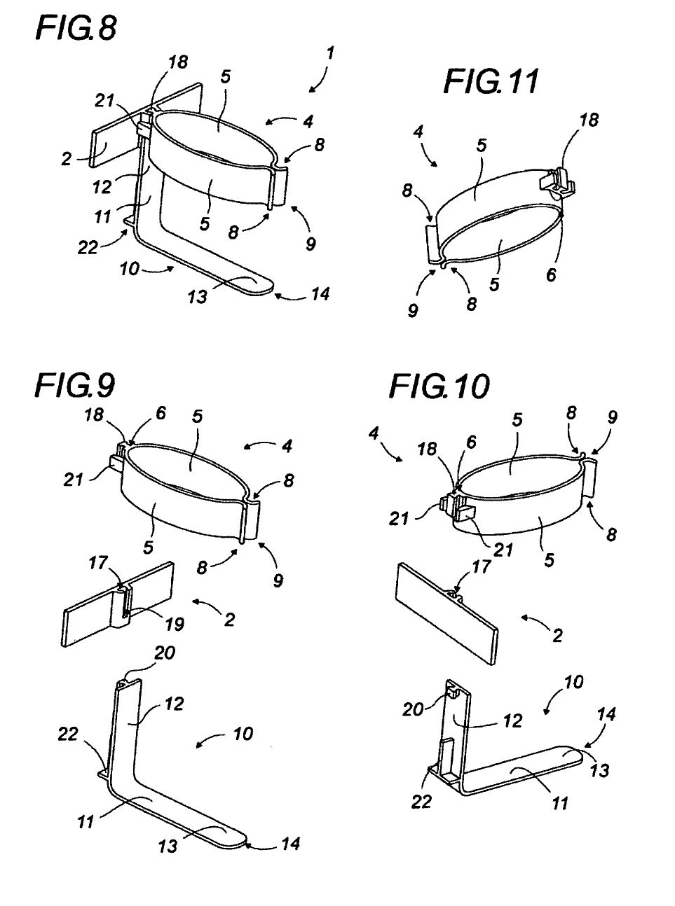

FIG. 8 is a perspective view of a vial holder according to a third variant of the invention;

FIG. 9 is a perspective view of the front of the vial holder of FIG. 8, shown disassembled and basically from the front and from the top;

FIG. 10 is a perspective view of the rear of the vial holder of FIG. 8, shown disassembled;

FIG. 11 is a perspective view of the removable clamp of the vial holder of FIG. 8;

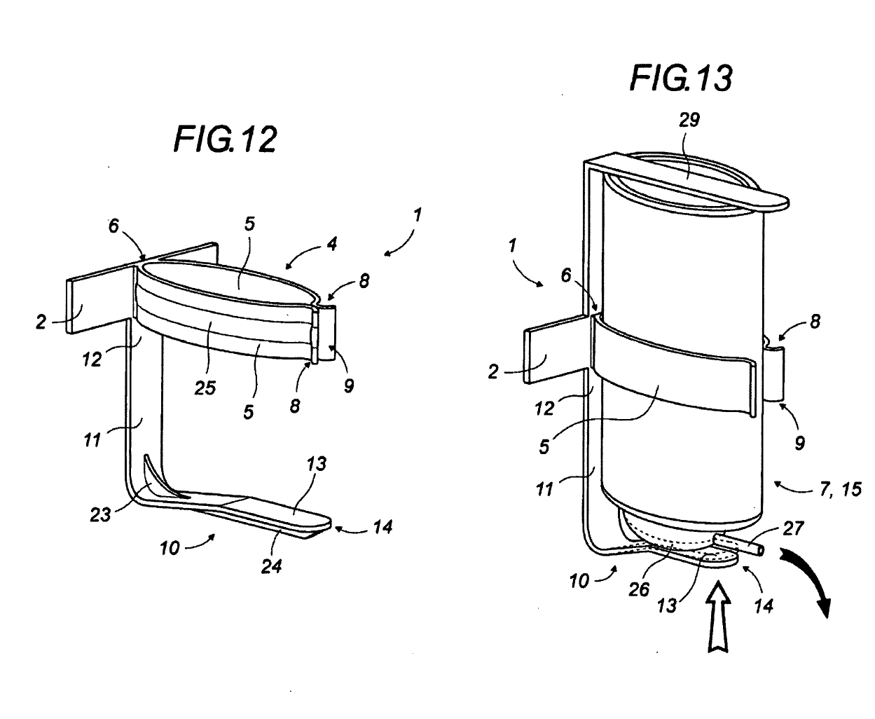

FIG. 12 is a perspective view of a vial holder including reinforcement structures;

FIG. 13 is a perspective view of a vial holder serving as a product dispenser in a first variant;

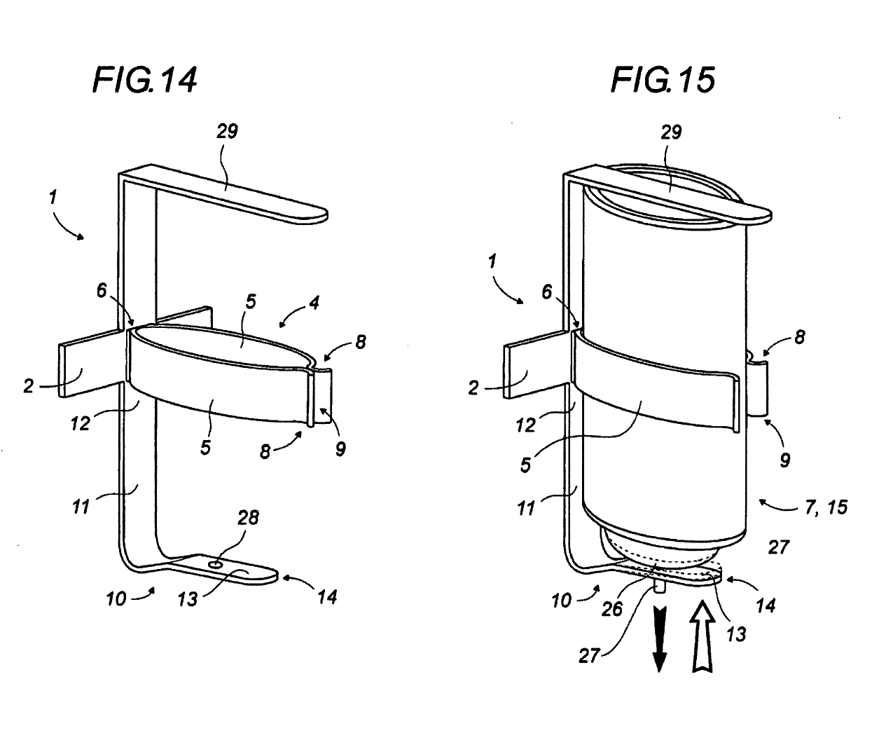

FIGS. 14 and 15 are perspective views of a vial holder serving as a product dispenser in a second variant; and

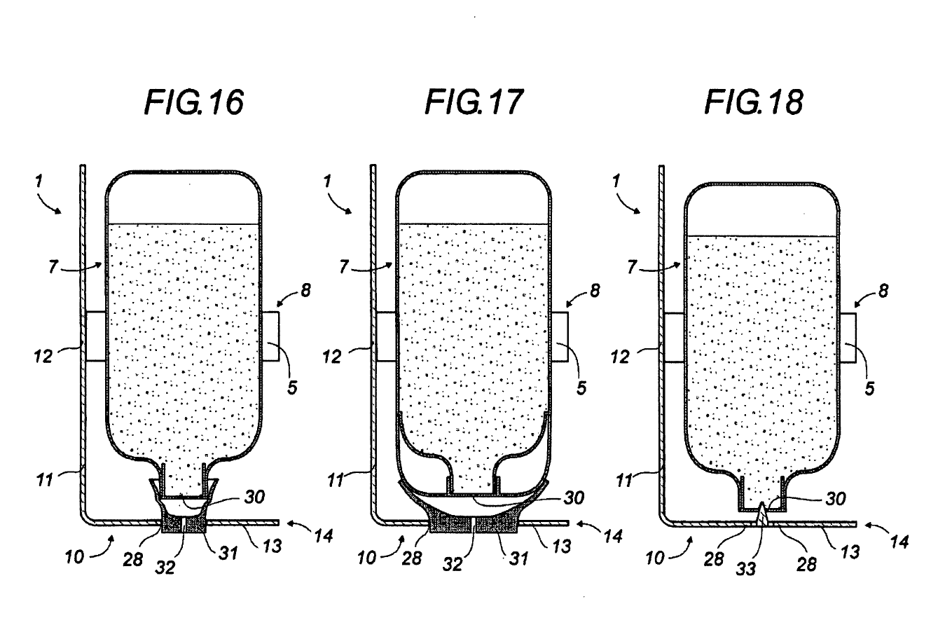

FIGS. 16 to 18 are vertical section views of a vial holder serving as a product dispenser in supplemental variants.

The vial holder of the present invention will now be described in detailed fashion, making reference to FIGS. 1 to 18. The equivalent elements shown in the different figures will bear the same reference numbers.

In the remainder of the description, the notions of top and bottom, lower and upper, etc. will be defined, as a function of the orientation taken up by the holder as shown in the different figures. It is obvious that this orientation will not necessarily be the same when in use.

The vial holder 1 according to the invention is preferably designed to be attached to a vertical wall. This attachment can be done, for example, by gluing, by screwing, by nailing, or by any other means of attachment or connection.

For this purpose, the vial holder according to the invention comprises a rear attachment platen 2, preferably in the form of a basically rectangular plate, designed to be placed against and secured to a vertical wall, such as a masonry wall. In the event that the vial holder 1 of the invention is to be attached to a wall by screwing or by nailing, perforations can be provided through the rear attachment platen 2.

This rear attachment platen 2 has one or more lateral clamping means 3 that are horizontally distributed. In one preferred embodiment of the invention, each lateral clamping means 3 is in the form of a clamp such as 4, basically perpendicular to the rear attachment platen 2, formed by two branches, for example, two opposing curved blades 5, bounding between them an interior holding volume of oblong cross section, such as oval, and open to the outside by an entry space.

Each curved blade 5 has a main curved part, convex toward the outside of the inner volume, so as to provide between it and its opposite neighbor the inner holding volume of general oblong shape, such as basically oval shape.

Each clamp 4 can be connected to the rear attachment platen 2 at the level of a first end 6.

The ends 6 of each clamp 4 can be joined to merge into a single common end, which can be connected to the rear attachment platen 2.

The curved blades 5 forming, two by two, each clamp 4 are thin enough to be able to be spread apart in elastic fashion without major effort by simply introducing the body of a vial 7 between them through the entry space and to hold it by virtue of a lateral clamping effect produced by the two opposing blades 5 of the clamps 4.

The opposing surfaces of each blade 5 of each pair of clamps 4 constitute contact surfaces with clamping effect, designed to immobilize the bodies of the vials 7 introduced laterally between them by their mere force of elastic closing and bearing against their sides.

In one preferred embodiment of the invention, the curved blades 5 are of a single piece with the rear attachment platen 2, the whole being connected to the wall by screwing, gluing, welding, or any other adapted means.

Preferably, the pairs of curved blades 5 forming each clamp 4 and the rear attachment platen 2 are made of plastic.

The other end 8 of each blade 5 of each clamp 4 is a free end having an inflection of curvature so that each blade 5 of each clamp 4 forms a terminal part 9 which is widened to the outside, constituting an entry space facilitating, through guidance, the lateral introduction of a vial 7 between them.

FIG. 1 shows a vial holder 1 according to a first embodiment of the invention, corresponding to the preceding description and comprising three pairs of clamps 4.

In use, the vials 7 to be immobilized are pushed laterally against the widened terminal part 9 of the clamps 4 forming the entry space so as to spread them apart and cause the vials 7 to be immobilized to go in between the clamps 4. Each clamp 4 is thus designed to receive a vial 7 in order to immobilize it by lateral clamping. The introduction of a vial 7 between two blades of a clamp 4 can also be done from the top of the clamps 4 by spreading them apart manually. The removal of a vial 7 is normally done by pulling on it laterally to remove it from the clamps 4. This movement can also be done, for example, upward, downward, but preferably toward the user, namely, by transverse removal from the vial holder 1.

Depending on the dimensions of the clamps 4, adapted to those of the vials 7 which they are able to accommodate and hold, the clamping force is sufficient to hold the vials 7 in suspension, but not present an abnormal resistance, i.e., not requiring a major force to introduce the vials laterally.

In a second preferred embodiment of the invention, represented in FIGS. 2 and 3, the vial holder 1 furthermore has a means of support 10 at each pair of clamps 4.

Each means of support 10 is preferably in the form of an additional support in the form of an L-shaped strip 11. The upper part 12 of this strip 11 is essentially vertical and connected to the rear attachment platen 2. The lower part 13 of the L-shaped strip is basically horizontal and has a free end 14 oriented away from the wall on which the vial holder 1 is secured.

Each means of support 10 is preferably centered vertically and laterally with respect to the clamp 4 with which it is associated.

In the embodiment of the invention shown in FIGS. 2 and 3, the means of support 10 of L-shaped strip 11, the clamps 4 and the rear attachment platen 2 are made of a single piece, for example, of plastic.

In use, when a vial 7 is held between clamps 4, it is supported at the bottom by the upper surface of the horizontal part 13 of the means of support 10 on which it rests.

In FIG. 3 is shown a vial holder 1 according to the second embodiment, in which two vials of different shape are immobilized. Thus, a first vial 7, 15 with general oval cross section is accommodated in a first clamp 4 and a second vial 7, 16 of circular cross section is accommodated in a second clamp 4, whose blades are slightly spread apart by it.

It will be obvious to the person versed in the art that the shape of the clamps of the holder 1 for at least one vial of the invention can be adapted to vials of different shapes.

Furthermore, as is shown in FIG. 4, the holder 1 for at least one vial according to the invention can serve at the same time to hold one or more vials upright, but also to hold one or more vials upside down.

The upside down position can be particularly advantageous, for example, to cause the contents of a vial to descend to the proximity of its outlet opening when it is nearly empty, or to be able to use a vial as a dispenser. In this latter case, after opening the vial, it is enough to press on it to cause a desired dose of product to emerge. In one preferred embodiment corresponding to this type of use, the means of support 10 on which the vial rests can be modified, for example, to have a shorter horizontal part or one having an opening through it, in order to allow the product to pass.

According to this preferred embodiment, each clamp 4 and/or each means of support 10 can be disassembled from the rear attachment platen 2.

According to a first variant of the invention shown in FIG. 5, each clamp 4 and the rear attachment platen 2 or each rear attachment platen 2 are not of a single piece. Thus, each clamp 4 can be disassembled from the rear attachment platen 2 and attached to it, in removable manner or not, for example by a vertical slide rail system 17, 18. Merely as an example, in FIGS. 5 and 6 there is shown a vertical slide rail system 17, 18 with cross section in the shape of a dovetail, comprising a female part 17 provided in the rear attachment platen 2, into which a male part 18, provided at the first end 6 of the pair of clamps 4, comes to slide. A stop 19 can be present in the lower part of the female part 17 of the slide rail so as to prevent further downward sliding causing emergence from the female part 17, especially when the fitting of the male part 18 in the female part 17 is not very firm.

Of course, the person versed in the art will be able to use any other suitable means of attachment.

Likewise, although a cross section of dovetail shape is preferred, one could use a cross section of different shape, for example, circular, square, triangular or other.

According to this first variant of the invention, the removable nature of each clamp 4 makes it possible to replace it, for example, when it is broken, or when one wishes to replace it with a clamp of different size.

According to a second variant of the invention shown in FIGS. 8 to 10, each clamp 4, each means of support 10 and the rear attachment platen 2 are not of a single piece. Thus, each clamp 4 and each means of support 10 can be disassembled from the rear attachment platen 2 and mounted therein, in removable fashion or otherwise, for example by a male part 18, 20 introduced into a female part 17 of a vertical slide rail, by a system of installation basically similar to that of the first variant. In addition to the replacement of a broken part or the changing of clamp size, this second variant of the invention simplifies the manufacture by a molding process and makes it possible to package the vial holders in disassembled state, which provides space savings and avoids possible damage caused by jolts during transport.

FIGS. 8 to 11 show a vial holder according to a third preferred embodiment of the invention, incorporating this second variant.

According to this embodiment, each pair of clamps 4 has a male part 18 at its first end 6, which is arranged to slide inside a female part 17 provided in the rear attachment platen 2. Likewise, each means of support 10, preferably in the shape of an auxiliary holder in the form of an L-shaped strip 11, has a male part 20 at its upper end, which is arranged to slide inside the female part 17 of the rear attachment platen 2.

A stop 19 can be present in the lower part of the female part 17 to prevent sliding of the pair of clamps 4 and the means of support 10 outside of the female part 17, especially when the fitting of the male parts 18 and 20 in the female part 17 is not very firm.

According to this embodiment, each pair of clamps 4 can furthermore have wedging projections 21 on either side of the male part 18, provided at its first end 6, to abut by their distal surface against the front surface of the rear attachment platen 2 and to abut by their lower surface against the upper surface of the upper part 12 of the means of support 10. These wedging projections ensure a positional wedging for each pair of clamps 4 so that, in use, the latter remains in position relative to the rest of the vial holder 1 and its male part 18 cannot be twisted or forced outside the female part 17.

According to this embodiment, each means of support 10 likewise contains a bearing projection 22 on its rear surface, for example, in the upper part 12 of the L-shaped strip 11. This projection 22 enables a bearing of the means of support against the vertical wall on which the vial holder 1 is secured or connected. It furthermore makes it possible to offset the deformation forces exerted by the weight of the vial against the lower part 13 of the L-shaped strip and sustained by the entire means of support 10.

According to this third preferred embodiment of the invention, the various parts 2, 4, 10 making up a vial holder 1 are packaged disassembled. In use, the rear attachment platen 2 is first secured or connected against a vertical wall. Next, the male part 20 of each means of support 10 is mounted by sliding in the female part 17 of the vertical slide rail system of the rear attachment platen 2 until it abuts against the stop 19 present in the lower part of the female part 17. Finally, the male part 18 of each pair of clamps 4 is inserted by sliding in the female part 17 of the vertical slide rail system of the rear attachment platen 2 until its lower surface abuts against the upper surface of the male part 20 of the means of support 10 previously put into place, and/or until the lower surface of the wedging projections 21 abuts against the upper surface of the upper part 12 of the means of support 10 previously put into place.

Obviously, the invention is not limited to the preferential embodiments described above and shown in the various Figures, and the person versed in the art can make many modifications and conceive of other variants without departing from the scope or the framework of the invention.

Thus, depending on the material of which the vial holder 1 is made and the thickness of its various parts, it may be necessary to add one or more reinforcement means or configurations 23, 24, to solidify the assembly, for example, in the form of ribs 23, 24 or reinforcement thickenings 25. As shown in FIG. 12, one can contemplate, for example, a means of reinforcement in the form of a rib 23 in the angle formed by the L-shaped strip 11, in the form of another rib 24 beneath the lower part 13 of the L-shaped strip, and in the form of a thickening 25 on the curved blades 5 of each pair of clamps 4.

According to another variant of the invention, in which the L-shaped strip 11 has instead a certain flexibility, one can contemplate using the vial holder of the invention as a holder for a dosing dispenser vial when using at least one vial 7 having a device 26 for stressing by means of compression, piston, or the like, making it possible to dispense the product which it contains at the bottom, for example, through an outlet opening, a dispensing nozzle, or an outlet tubing 27 when the user presses on this device 26. One will select a dosing dispenser vial designed to be used upside down. To make the product come out, the user exerts an upward pressure on the stressing device 26 of the vial 7 via the lower part 13 of the means of support 10 by pressing the latter upward.

This variant considerably facilitates the use of the vials and, in particular, lets one dispense the product contained in a vial by using one's elbow or another part of the body, without having to touch the vial with dirty hands.

In FIG. 13, we have shown the case when the outlet tubing 27 is essentially horizontal. Note that, in this case, the dosing dispenser vial can also be used in the upright position.

In FIGS. 14 and 15 there is shown a second variant of the vial holder of the invention, used as a holder for a dosing dispenser vial having an essentially vertical outlet tubing 27. In this case, the lower part 13 of the L-shaped strip has a through-opening 28 for passage of the exit outlet tubing 27 of the vial 7.

This variant ensures a supplemental holding of the vial 7 by the wedging of the lower part, due to the exit outlet tubing 27 passing through the lower flexible foot 13.

To prevent the possible lifting of the vial 7 when the user exerts an upward pressure on the stressing device 26, the means of support 10 can have in its upper part an upper holder in the form of an L-shaped strip 29. The lower part of this strip is basically vertical and connected to the rear attachment platen 2, while its upper part is basically horizontal and has a free end away from the wall to which the vial holder 1 is attached.

Especially in the case of vials of the type with forced exiting of product by compressing their flexible body, one can contemplate, finally, a third variant of the vial holder of the invention. In this variant, the vial 7 has an exit opening 30, for example a slit, which opens beyond a pressure threshold of the product contained. The opening pressure is that exerted by the user, for example on the sides of the flexible vial 7. This might involve flexible lips that spread apart only beyond a certain pressure.

The configuration of the exit end of this kind of vial is quite variable, but it is generally in the form of a central projection, forming the neck of the vial, for example, at the central end of which the exit opening 30 is situated.

To guarantee tightness, the exit opening 30 is often blocked by a removable cap (not shown).

The variant consists in providing a universal accommodation part 31 for this central projection, while the flexible vial 7 is preferably held upside down and the lower part 13 of the L-shaped strip has a continuous opening 28 for passage of the product from the vial 7.

The universal accommodation part 31 can have, in its upper part, the general shape of a conical or truncated conical cup, in which the projecting central end of the vial 7 will fit.

To guarantee tightness, one can provide an annular bead, produced by inserting the end of the vial 7 in the flexible truncated conical part of the accommodation part 31. One can also provide an annular snap-on bead, preshaped to the dimensions of this end, which holds the projecting central end inside the universal accommodation part.

As for the mounting of the universal accommodation part on the lower part 13 of the L-shaped strip, it can be done by any means of connection or attachment. Removable attachment can result from the use of a threading or a form fitting between the continuous base of the universal accommodation part 31 and the lower part 13 of the L-shaped strip.

One can also provide an internal threading or notched structures intended to immobilize the central projection in the universal accommodation part.

The universal accommodation part 31 is preferably made of flexible elastic material, such as rubber. It can be made from any other material and be, for example, of one piece with the lower part 13 of the L-shaped strip.

Of course, it is possible to make an accommodation part adapted to any shape of vial.

In FIGS. 16 and 17 we have shown a vial holder of the invention used as holder for a dosing dispenser vial according to this variant. These Figures involve an improved version of the holder in which the lower part 13 of the L-shaped strip has a universal accommodation part 31. This universal accommodation part 31 has a through-opening 32 for passage of the product contained in the vial 7. It makes it possible to wedge the vial by its bottom part so as to position its dispensing opening 30 basically opposite the through opening-s 32 of the L-shaped strip.

Another variant is represented in FIG. 18 for a vial holder wherein the through-opening 28 present in the lower part 13 of the L-shaped strip has at its center a central shutting spike 33, for example, of conical shape, designed to go into the exit opening 30 of a vial 7 upside down, so as to close this opening. The shutting spike 33 is maintained, for example, by radial struts. The weight of the vial 7 and its contents exerts a pressure on the shutting spike 33 which prevents the product contained in the vial 7 from running out from its exit opening 30. To let the product emerge from the vial, the user exerts a pressure on the vial 7, for example on its sides, until a pressure threshold is reached for the contained product that is sufficient to counter the force exerted by the weight of the vial 7. The product contained in the vial 7 can then emerge from it by forced passage through the exit opening 30, to run along the external surface of the shutting spike 33 and pass through the opening 28 extending partially around the latter.

The conical shape of the shutting spike 33 is preferred, since this can be adapted advantageously to different diameters of exit opening 30 of vials 7. Furthermore, the penetration of the shutting spike 33 through the exit opening 30 of the vial 7 enables a holding and centering of the latter by its bottom part.

This variant makes it possible to use any vial 7 having a circular or essentially circular exit opening 30 as a squeeze-type vial.

Of course, the shape of the shutting spike 33 can be adapted to other shapes of exit opening 30 of vial 7.

Finally, although the different Figures show each time only a single or three pairs of clamps, the vial holder 1 of the invention can contain any number of pairs of clamps.

Moreover, although FIGS. 1 to 5 show each time pairs of clamps of identical shapes and dimensions, these clamps can have variable and different shapes and dimensions so as to be able to adapt the vial holder of the invention to vials with equally variable and different shapes and dimensions. Thus, as an example, the vial holder 1 of FIG. 7 has two types of different dimensions for the pairs of clamps 4, making it possible to adapt them to vials or tubes of different gauges.

It will be noted that the different preferred embodiments, whether or not incorporating one or another of the different variants, can be very easily manufactured by molding of a suitable plastic at an extremely reduced cost.

1-26. (canceled)

27. A vial container holder for at least one vial container, comprising:
a rear attachment platen adapted to be fixedly secured to a support wall; and
at least one clamping mechanism, attached to said rear attachment platen, for holding at least one vial container,
said at least one clamping mechanism comprising a pair of oppositely disposed, arcuately curved, elastically flexible clamping blade members attached at rearward end portions to said rear attachment platen and having forward end portions disposed adjacent to each other such that a vial container accommodation space is defined internally between said pair of oppositely disposed, arcuately curved, elastically flexible clamping blade members for accommodating a vial container, wherein said forward end portions of said clamping blade members are laterally spaced from each other so as to define an entry point through which the vial container may be inserted into said vial container accommodation space defined between said pair of clamping blade members, and wherein said elastically flexible clamping blade members are capable of being laterally spread apart and separated with respect to each other from initial positions in order to permit entry of the vial container through said entry point and into said vial container accommodation space defined between said pair of clamping blade members, whereupon, after insertion of the vial container into said vial container accommodation space defined between said pair of clamping blade members, said pair of elastically flexible clamping blade members will move toward each other and back toward said initial positions so as to thereby securely retain the vial container between said pair of clamping blade members.

28. The vial container holder as set forth in claim 27, wherein:
said at least one clamping mechanism, comprising a pair of oppositely disposed, arcuately curved, elastically flexible clamping blade members attached at rearward end portions to said rear attachment platen and having forward end portions disposed adjacent to each other, comprises a plurality of clamping mechanisms each comprising a pair of oppositely disposed, arcuately curved, elastically flexible clamping blade members attached at rearward end portions to said rear attachment platen and having forward end portions disposed adjacent to each other for respectively defining vial container accommodation spaces.

29. The vial container holder as set forth in claim 27, wherein:
said forward end portions of said clamping blade members have curvatures which are the reverse of the curvatures of said arcuately shaped clamping blade members so as to effectively define a convergent entranceway to said entry point and thereby facilitate the entry of the vial container through said entry point and into said vial container accommodation space defined between said pair of clamping blade members.

30. The vial container holder as set forth in claim 27, wherein:
said at least one clamping mechanism is removably attached to said rear attachment platen.

31. The vial container holder as set forth in claim 30, wherein:
said at least one clamping mechanism is removably attached to said rear attachment platen by first mating structure defined upon both said at least one clamping mechanism and said rear attachment platen.

32. The vial container holder as set forth in claim 31, wherein said first mating structure, defined upon both said at least one clamping mechanism and said rear attachment platen, comprises:
a male member, comprising a male tenon, defined upon said at least one clamping mechanism; and
a female member, comprising a female mortise slide rail member, defined upon said rear attachment platen such that together, said male tenon of said at least one clamping member and said female mortise slide rail member of said rear attachment platen comprise a dovetail joint.

33. The vial container holder as set forth in claim 32, wherein:
a support member is attached to said rear attachment platen and comprising a first structure disposed beneath said pair of clamping blade members so as to support a lower end portion of the vial container when the vial container is disposed and secured within said vial container accommodation space defined between said pair of clamping blade members.

34. The vial container holder as set forth in claim 34, wherein:
said first structure of said support member is removably attached to said rear attachment platen by second mating structure defined upon both said support member and said rear attachment platen.

35. The vial container holder as set forth in claim 31, wherein said second mating structure, defined upon both said first support structure of said support member and said rear attachment platen, comprises:
a male member, comprising a male tenon, defined upon said first structure of said support member; and
a female member, comprising said female mortise slide rail member of said rear attachment platen, such that together, said male tenon of said first structure of said support member and said female mortise slide rail member of said rear attachment platen comprise a dovetail joint.

36. The vial container holder as set forth in claim 35, wherein:
a stop member is defined within a lower end portion of said female slide rail member of said rear attachment platen for supporting said male tenon of said first structure of said support member such that said male tenon of said first structure of said support member will be secured within said female slide rail member of said rear attachment platen; and
said male tenon of said at least one clamping mechanism is disposed atop said male tenon of said first structure of said support member such that said male tenon of said at least one clamping mechanism is likewise secured within said female slide rail member of said rear attachment platen.

37. The vial container holder as set forth in claim 33, wherein:
said first structure of said support member has a substantially L-shaped cross-sectional configuration wherein a first leg portion of said first structure of said support member extends vertically upwardly such that an upper end portion thereof is attached to said rear attachment platen, while a second leg portion of said first structure extends forwardly and horizontally away from said rear attachment platen so as to be disposed beneath the lower end portion of the vial container and thereby support the vial container thereon.

38. The vial holder as set forth in claim 27, wherein:
said rear attachment platen and said pair of clamping blade members are fabricated from a thermoplastic material.

39. The vial container holder as set forth in claim 27, wherein:
said vial container accommodation space defined between said pair of clamping blade members has a substantially oval-shaped cross-sectional configuration.

40. The vial container holder as set forth in claim 37, wherein:
said second leg portion of said first structure of said support member comprises a flexible portion so as to be upwardly movable in order to contact a dispensing mechanism of the vial container in order to dispense a product contained within the vial container.

41. The vial container holder as set forth in claim 39, wherein:
an aperture is defined within said second leg portion of said first structure of said support member so as to permit product, dispensed from the vial container, to pass through said second leg portion of said first structure of said support member supporting the lower end portion of the vial container when said second leg portion of said first structure of said support member is moved upwardly into contact with the dispensing mechanism of the vial container in order to effectuate the dispensing of the product from the vial container.

42. The vial container holder as set forth in claim 41, wherein:
said support member attached to said rear attachment platen comprises a second structure disposed above said pair of clamping blade members so as to engage an upper portion of the vial container in order to prevent the vial container from being inadvertently removed from its disposition within said vial container accommodation space defined between said pair of clamping blade members when said second flexible leg portion of said first structure of said support member is moved upwardly into contact with the dispensing mechanism of the vial container in order to dispense the product contained within the vial container.

43. The vial container holder as set forth in claim 42, wherein:
said second structure has a substantially L-shaped cross-sectional configuration wherein a first leg portion of said second structure extends vertically downwardly such that an lower end portion thereof is attached to said rear attachment platen, while a second leg portion of said second structure extends forwardly and horizontally away from said rear attachment platen so as to be disposed above the upper end portion of the vial container and thereby prevent any upward movement of the vial container relative to its disposition within said vial container accommodation space defined between said pair of clamping blade members.

44. The vial container holder as set forth in claim 37, wherein:
a bearing projection is mounted upon said first leg portion of said first structure of said support member so as to support said first leg portion of said first structure of said support member upon the vertical wall upon which said rear attachment platen is fixedly secured.

45. The vial container holder as set forth in claim 33, wherein:
structural ribs are provided upon said pair of clamping blade members and said support member so as to enhance the structural integrity of said clamping blade members and said support member.

46. The vial container holder as set forth in claim 37, further comprising:
a universal accommodation support member mounted upon said second leg portion of said first structure of said support member so as to permit different vial containers to be mounted upon said vial container holder.

47. The vial container holder as set forth in claim 37, wherein:
an upwardly projecting spike is fixedly secured upon said second leg portion of said first structure for sealingly projecting into a closure cap of a flexible vial container when the flexible vial container is disposed in an upside-down position upon said second leg portion of said first structure so as to prevent dispensing of a product from the flexible vial container when dispensing is not desired, and yet permit-ting dispensing of the product from the flexible container when dispensing of the product is desired by flexing side wall portions of the flexible container.

48. The vial container holder as set forth in claim 27, wherein:
said at least one clamping mechanism is integrally attached to said rear attachment platen so as to define with said rear attachment platen a one-piece structure.
